(19) United States
(12) Patent Application Publication
(10) Pub. No.: US 2026/0265119 A1
(43) Pub. Date: Sep. 10, 2026

(54) BIOACTIVE GLASS COMPOSITIONS

(71) Applicant: CORNING INCORPORATED, CORNING, NY (US)

(72) Inventors: Erin Coon, Providence, RI (US); Qiang Fu, Painted Post, NY (US); Aize Li, Painted Post, NY (US)

(21) Appl. No.: 19/660,704

(22) Filed: Apr. 28, 2026

Related U.S. Application Data
(63) Continuation of application No. 17/186,044, filed on Feb. 26, 2021, now abandoned.

(51) Int. Cl. C03C 4/00; C03C 3/085

(52) U.S. Cl. CPC C03C 4/0021; C03C 3/085; C03C 2204/00

(57) ABSTRACT

A silicate-based glass composition includes 15-65 wt. % SiO₂, 2.5-25 wt. % MgO, 1-30 wt. % P₂O₅, and 15-50 wt. % CaO. The glass composition may also include 0-5 wt. % F⁻, and 0-10 wt. % ZrO₂. The glass composition may also include one of 0-10 wt. % Al₂O₃, 0-10 wt. % SrO, and 0-10 wt. % ZnO.

### CROSS-REFERENCE TO RELATED APPLICATIONS

This application is a continuation of U.S. application Ser. No. 17/186,044, filed on Feb. 26, 2021, the content of which is relied upon and incorporated herein by reference in its entirety.

### FIELD

The disclosure relates to biocompatible inorganic compositions for consumer and dental applications.

### BACKGROUND

Bioactive glasses are a group of glass and glass ceramic materials that have shown biocompatibility or bioactivity, which has allowed them to be incorporated into human or animal physiology. Generally speaking, bioactive glasses are able to bond with hard and soft tissues, thereby fostering growth of bone and cartilage cells. Moreover, bioactive glasses may also enable release of ions which activate expression of osteogenic genes and stimulate angiogenesis, as well as promote vascularization, wound healing, and cardiac, lung, nerve, gastrointestinal, urinary tract, and laryngeal tissue repair.

Currently available bioactive glasses are being investigated for their ability to convert to apatite; however, the low chemical durability of these traditional bioactive glasses are problematic for compositions requiring prolonged shelf times in aqueous environments. For example, 45S5 Bioglass® requires development of a non-aqueous environment for glass particulates to be used in toothpaste applications. Other glass compositions (e.g., alkali-free glasses) do not exhibit the bioactivity of alkali-containing compositions. Thus, there continues to be an unmet need for bioactive glass compositions having high bioactivity while remaining chemically durable in aqueous environments.

This disclosure presents improved biocompatible inorganic compositions for consumer and dental applications.

### SUMMARY

In some embodiments, a silicate-based glass composition comprises: 15-65 wt. % SiO₂, 2.5-25 wt. % MgO, 1-30 wt. % P₂O₅, and 15-50 wt. % CaO. In one aspect, which is combinable with any of the other aspects or embodiments, the composition further comprises: 0-5 wt. % F⁻, and 0-10 wt. % ZrO₂. In one aspect, which is combinable with any of the other aspects or embodiments, the composition further comprises: 0-10 wt. % Al₂O₃, 0-10 wt. % SrO, and 0-10 wt. % ZnO. In one aspect, which is combinable with any of the other aspects or embodiments, the glass comprises: 15-50 wt. % MO, and 0-30 wt. % R₂O, wherein MO is the sum of MgO, CaO, SrO, BeO, and BaO, and R₂O is the sum of Na₂O, K₂O, Li₂O, Rb₂O, and Cs₂O.

In some embodiments, a silicate-based glass composition comprises: 15-65 wt. % SiO₂, 2.5-25 wt. % MgO, 1-30 wt. % P₂O₅, 15-50 wt. % CaO, 0-5 wt. % F⁻, and 0-10 wt. % ZrO₂. In one aspect, which is combinable with any of the other aspects or embodiments, the composition further comprises one of: 0-10 wt. % Al₂O₃, 0-10 wt. % SrO, and 0-10 wt. % ZnO.

In some embodiments, a silicate-based glass composition comprises: 20-55 wt. % SiO₂, 5-20 wt. % MgO, 5-25 wt. % P₂O₅, and 25-45 wt. % CaO. In one aspect, which is combinable with any of the other aspects or embodiments, the composition further comprises: 0-3 wt. % F⁻, and 0-6 wt. % ZrO₂. In one aspect, which is combinable with any of the other aspects or embodiments, the composition further comprises: 0-5 wt. % Al₂O₃, 0-5 wt. % SrO, and 0-5 wt. % ZnO.

In one aspect, which is combinable with any of the other aspects or embodiments, a glass composition described herein further comprises: a bioactive ceramic within fourteen days of immersion in a salt solution. In one aspect, which is combinable with any of the other aspects or embodiments, the bioactive ceramic is brushite. In one aspect, which is combinable with any of the other aspects or embodiments, the salt solution is potassium phosphate.

In one aspect, which is combinable with any of the other aspects or embodiments, a glass composition described herein has a melting temperature of below 1300° C. In one aspect, which is combinable with any of the other aspects or embodiments, a glass composition described herein has a sum of P₂O₅ and CaO is from 25-65 wt. %. In one aspect, which is combinable with any of the other aspects or embodiments, a glass composition described herein further comprises: an apatite when immersed in a simulated body fluid (SBF). In one aspect, which is combinable with any of the other aspects or embodiments, a glass composition described herein is essentially free of Na₂O and K₂O. In one aspect, which is combinable with any of the other aspects or embodiments, a glass composition described herein is a particle, bead, particulate, short fiber, long fiber, woolen mesh, combination thereof. In one aspect, which is combinable with any of the other aspects or embodiments, a glass composition described herein has at least one size dimension in a range of 1-100 μm. In one aspect, which is combinable with any of the other aspects or embodiments, a glass composition described herein has at least one size dimension in a range of 1-10 μm.

In some embodiments, a matrix comprises a glass composition described herein such that the matrix includes at least one of: a toothpaste, mouthwash, rinse, spray, ointment, salve, cream, bandage, polymer film, oral formulation, pill, capsule, or transdermal formulation. In one aspect, which is combinable with any of the other aspects or embodiments, the glass composition is attached to the matrix or mixed therein. In one aspect, which is combinable with any of the other aspects or embodiments, an aqueous environment comprises a glass composition described herein.

### BRIEF DESCRIPTION OF THE DRAWINGS

The disclosure will become more fully understood from the following detailed description, taken in conjunction with the accompanying figures, in which:

FIG. 1 illustrates weight loss characterization of Examples 1-4 and Comparative Example 1 when immersed in artificial saliva at 37° C. for 7 days, according to some embodiments.

FIG. 2 illustrates equivalent alkali per gram of Examples 1 and 2 and Comparative Examples 1 and 2 when tested in water at 98° C. for 1 hr according to ISO 719 standard procedure, according to some embodiments.

FIG. 3 illustrates powder x-ray diffraction (XRD) analysis on Examples 1 and 2 and Comparative Example 1 after soaking in KH₂PO₄ at 25° C. for 14 days, according to some embodiments.

### DETAILED DESCRIPTION

In the following description, whenever a group is described as comprising at least one of a group of elements and combinations thereof, it is understood that the group may comprise, consist essentially of, or consist of any number of those elements recited, either individually or in combination with each other. Similarly, whenever a group is described as consisting of at least one of a group of elements or combinations thereof, it is understood that the group may consist of any number of those elements recited, either individually or in combination with each other. Unless otherwise specified, a range of values, when recited, includes both the upper and lower limits of the range as well as any ranges therebetween.

Where a range of numerical values is recited herein, comprising upper and lower values, unless otherwise stated in specific circumstances, the range is intended to include the endpoints thereof, and all integers and fractions within the range. It is not intended that the scope of the claims be limited to the specific values recited when defining a range. Further, when an amount, concentration, or other value or parameter is given as a range, one or more preferred ranges or a list of upper preferable values and lower preferable values, this is to be understood as specifically disclosing all ranges formed from any pair of any upper range limit or preferred value and any lower range limit or preferred value, regardless of whether such pairs are separately disclosed. Finally, when the term “about” is used in describing a value or an end-point of a range, the disclosure should be understood to include the specific value or end-point referred to. When a numerical value or end-point of a range does not recite “about,” the numerical value or end-point of a range is intended to include two embodiments: one modified by “about,” and one not modified by “about.”

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. It is noted that the terms “substantially” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue. Thus, for example, a glass that is “free” or “essentially free” of Al₂O₃ is one in which Al₂O₃ is not actively added or batched into the glass, but may be present in very small amounts as a contaminant (e.g., 500, 400, 300, 200, or 100 parts per million (ppm) or less or).

Herein, glass compositions are expressed in terms of wt % amounts of particular components included therein on an oxide bases unless otherwise indicated. Any component having more than one oxidation state may be present in a glass composition in any oxidation state. However, concentrations of such component are expressed in terms of the oxide in which such component is at its lowest oxidation state unless otherwise indicated.

Unless otherwise specified, all compositions are expressed in terms of weight percent (wt %). The annealing point (° C.) may be measured using a beam bending viscometer (ASTM C598-93).

### Glass Compositions

Bioactive glasses are a group of glass and glass ceramic materials that have shown biocompatibility or bioactivity, which has allowed them to be incorporated into human or animal physiology. In the glass compositions described herein, SiO₂ serves as the primary glass-forming oxide in combination with the bioactive oxides of calcium and phosphorous.

In some examples, the glass comprises a combination of SiO₂, MgO, P₂O₅, and CaO. In some examples, the glass further comprises Al₂O₃, SrO, F⁻, and/or ZrO₂. In some examples, may further comprise ZnO, B₂O₃, Na₂O, K₂O, and/or Li₂O. For example, the glass may comprise a composition including, in wt. %: 15 to 65% SiO₂, 2.5 to 25% MgO, 1 to 30% P₂O₅, and 15 to 50% CaO. In some examples, the glass may further comprise, in wt. %: 0 to 10% Al₂O₃, 0 to 10% SrO, 0 to 5% F⁻, and/or 0 to 10% ZrO₂. In some examples, the glass may further comprise, in wt. %: 0 to 10% ZnO, 0 to 5% B₂O₃, 0 to 0.5% Na₂O, and/or 0 to 0.5% K₂O. In some examples, the glass comprises, in wt. %: 15 to 50 MO and 0-30 R₂O, wherein MO is the sum of MgO, CaO, SrO, BeO, and BaO and R₂O is the sum of Na₂O, K₂O, Li₂O, Rb₂O, and Cs₂O. The silicate glasses disclosed herein are particularly suitable for consumer, dental, or bioactive applications.

Silicon dioxide (SiO₂), which serves as the primary glass-forming oxide component of the embodied glasses, may be included to provide high temperature stability and chemical durability. For the glasses disclosed herein, compositions including excess SiO₂ (e.g., greater than 60 wt. %) suffer from decreased bioactivity. Moreover, glasses containing too much SiO₂ often also have too high melting temperatures (e.g., greater than 200 poise temperature).

In some embodiments, the glass can comprise 15-65 wt. % SiO₂. In some examples, the glass may comprise 20-55 wt. % SiO₂. In some examples, the glass can comprise 15-65 wt. %, or 15-55 wt. %, or 20-55 wt. %, or 20-50 wt. %, or 25-50 wt. %, or 25-45 wt. %, or 30-45 wt. %, or 30-40 wt. %, or any value or range disclosed therein. In some examples, the glass comprises 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, or 65 wt. % SiO₂, or any value or range having endpoints disclosed herein.

In some examples, the glasses comprise MgO. In some examples, the glass can comprise 2.5-25 wt. % MgO. In some examples, the glass can comprise 5-20 wt. % MgO. In some examples, the glass can comprise from 2.5-25 wt. %, or 2.5-22.5 wt. %, or 5-22.5 wt. %, or 5-20 wt. %, or 7.5-20 wt. %, or 7.5-17.5 wt. %, or 10-17.5 wt. %, or 10-15 wt. % MgO, or any value or range disclosed therein. In some examples, the glass can comprise 2.5, 3, 4, 5, 6, 7, 8, 9, 10, 11, 12, 13, 14, 15, 16, 17, 18, 19, 20, 21, 22, 23, 24, or 25 wt. % MgO, or any value or range having endpoints disclosed herein.

Phosphorus pentoxide (P₂O₅) also serves as a network former. Furthermore, the liberation of phosphate ions to the surface of bioactive glasses contributes to the formation of apatite. Apatite is an inorganic mineral in bone and teeth, and formation of apatite in a simulated body fluid is one criteria for a material to be bioactive, according to ASTM F1538-03 (2017). The inclusion of phosphate ions in the bioactive glass increases apatite formation rate and the binding capacity of the bone tissue. In addition, P₂O₅ increases the viscosity of the glass, which in turn expands the range of operating temperatures, and is therefore an advantage to the manufacture and formation of the glass. In some examples, the glass can comprise 1-30 wt. % P₂O₅. In some examples, the glass can comprise 5-25 wt. % P₂O₅. In some examples, the glass can comprise 1-30 wt. %, or 3-30 wt. %, or 3-27 wt. %, or 5-27 wt. %, or 5-25 wt. %, or 7-25 wt. %, or 7-23 wt. % P₂O₅, or any value or range disclosed therein. In some examples, the glass can comprise about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30 wt. % P₂O₅, or any value or range having endpoints disclosed herein.

In some examples, the glass can comprise 15-50 wt. % CaO. In some examples, the glass can comprise 25-45 wt. % CaO. In some examples, the glass can comprise from 15-50 wt. %, or 20-50 wt. %, or 20-45 wt. %, or 25-45 wt. %, or 25-40 wt. % CaO, or any value or range disclosed therein. In some examples, the glass can comprise 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50 wt. % CaO, or any value or range having endpoints disclosed herein.

Divalent cation oxides (such as alkaline earth oxides) also improve the melting behavior, chemical durability, and bioactivity of the glass. Particularly, CaO is found to be able to react with P₂O₅ to form apatite when immersed in a simulated body fluid (SBF) or in vivo. The release of Ca²⁺ ions from the surface of the glass contributes to the formation of a layer rich in calcium phosphate. Thus, the combination of P₂O₅ and CaO may provide advantageous compositions for bioactive glasses. In some examples, the glass compositions comprise P₂O₅ and CaO with the sum of P₂O₅ and CaO being from 25-65 wt. %, or 25-60 wt. %, or 30-60 wt. %, or 30-55 wt. %, or 35-55 wt. %, or any value or range disclosed therein. In some examples, the glass compositions comprise P₂O₅ and CaO with the sum of P₂O₅ and CaO being 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, or 65 wt. %, or any value or range having endpoints disclosed herein.

Alumina (Al₂O₃) may influence (i.e., stabilize) the structure of the glass and, additionally, lower the liquidus temperature and coefficient of thermal expansion, or, enhance the strain point. In addition to its role as a network former, Al₂O₃ (and ZrO₂) help improve the chemical durability and mechanical properties in silicate glass while having no toxicity concerns. Too high a content of Al₂O₃ (e.g., >10 wt. %) generally increases the viscosity of the melt and decreases bioactivity. With respect to ZrO₂, in addition to its role as a network former or intermediate in the precursor glasses, ZrO₂ is a key oxide for improving glass thermal stability by significantly reducing glass devitrification during forming and lowering liquidus temperature. In certain aspects, ZrO₂ may play a similar role as Al₂O₃ in the composition. In some examples, the glass can comprise 0-10 wt. % Al₂O₃ and/or ZrO₂. In some examples, the glass can comprise from 0-10 wt. %, 0-8 wt. %, 0-6 wt. %, 0-4 wt. %, 0-2 wt. %, >0-10 wt. %, >0-8 wt. %, >0-6 wt. %, >0-4 wt. %, >0-2 wt. %, 1-10 wt. %, 1-8 wt. %, 1-6 wt. %, 1-4 wt. %, 1-2 wt. %, 3-8 wt. %, 3-6 wt. %, 3-10 wt. %, 5-8 wt. %, 5-10 wt. %, 7-10 wt. %, or 8-10 wt. % Al₂O₃ and/or ZrO₂, or any value or range disclosed therein. In some examples, the glass can comprise 0, >0, 1, 2, 3, 4, 5, 6, 7, 8, 9, or 10 wt. % Al₂O₃ and/or ZrO₂, or any value or range having endpoints disclosed herein.

Strontium oxide (SrO) may be present in some embodiments and in such examples, the glass can comprise from 0-10 wt. % SrO. In some examples, the glass can comprise from >0-10 wt. % SrO. In some examples, the glass can comprise from 3-10 wt. %, 5-10 wt. %, 5-8 wt. % SrO, or any value or range disclosed therein. In some examples, the glass can comprise from 0-10 wt. %, 0-8 wt. %, 0-6 wt. %, 0-4 wt. %, 0-2 wt. %, >0-10 wt. %, >0-8 wt. %, >0-6 wt. %, >0-4 wt. %, >0-2 wt. %, 1-10 wt. %, 1-8 wt. %, 1-6 wt. %, 1-4 wt. %, 1-2 wt. %, 3-8 wt. %, 3-6 wt. %, 3-10 wt. %, 5-8 wt. %, 5-10 wt. %, 7-10 wt. %, or 8-10 wt. % SrO, or any value or range disclosed therein. In some examples, the glass can comprise about >0, 1, 2, 3, 4, 5, 6, 7, 8, 9, or 10 wt. % SrO, or any value or range having endpoints disclosed herein.

Fluorine (F⁻) may be present in some embodiments and in such examples, the glass can comprise from 0-5 wt. % F. In some examples, the glass can comprise from >0-5 wt. % F. In some examples, the glass can comprise from 0-5 wt. %, >0-5 wt. %, >0-4 wt. %, >0-3 wt. %, >0-2.5 wt. %, >0-2 wt. %, F⁻, or any value or range disclosed therein. In some examples, the glass can comprise about 0, >0, 0.5, 1, 1.5, 2, 2.5, 3, 3.5, 4, 4.5, or 5 wt. % F⁻, or any value or range having endpoints disclosed herein. F⁻ can combine with CaO and P₂O₅ to form fluorapatite to improve the bioactivity of the claimed compositions. Fluorapatite is an inorganic mineral in dental enamel. The ability to form fluorapatite can help regeneration the enamel due to cavities.

In some examples, the glasses comprise ZnO. In some examples, the glass can comprise 0-10 wt. % ZnO. In some examples, the glass can comprise from 0-5 wt. % ZnO. In some examples, the glass can comprise from >0-10 wt. %, 3-10 wt. %, or 3-8 wt. % ZnO, or any value or range disclosed therein. In some examples, the glass can comprise from 0-10 wt. %, 0-8 wt. %, 0-6 wt. %, 0-4 wt. %, 0-2 wt. %, >0-10 wt. %, >0-8 wt. %, >0-6 wt. %, >0-4 wt. %, >0-2 wt. %, 1-10 wt. %, 1-8 wt. %, 1-6 wt. %, 1-4 wt. %, 1-2 wt. %, 3-8 wt. %, 3-6 wt. %, 3-10 wt. %, 5-8 wt. %, 5-10 wt. %, 7-10 wt. %, or 8-10 wt. % ZnO, or any value or range disclosed therein. In some examples, the glass can comprise about 0, >0, 1, 2, 3, 4, 5, 6, 7, 8, 9, or 10 wt. % ZnO, or any value or range having endpoints disclosed herein.

In some examples, the glass can comprise 0-5 wt. % B₂O₃. In some examples, the glass can comprise >0-5 wt. % B₂O₃. In some examples, the glass can comprise from 0-5 wt. %, or >0-5 wt. %, or 2-5 wt. % B₂O₃, or any value or range disclosed therein. In some examples, the glass can comprise 0, >0, 1, 2, 3, 4, or 5 wt. % B₂O₃, or any value or range having endpoints disclosed herein.

In some examples, the glass can comprise from 0-5 wt. % Na₂O and/or K₂O. In some examples, the glass can comprise >0-5 wt. % Na₂O and/or K₂O. In some examples, the glass can comprise about 0, >0, 1, 2, 3, 4, or 5 wt. % Na₂O and/or K₂O, or any value or range having endpoints disclosed herein.

Alkaline earth oxides may improve other desirable properties in the materials, including influencing the Young's modulus and the coefficient of thermal expansion. In some examples, the glass comprises from 15-50 wt. % MO, wherein MO is the sum of MgO, CaO, SrO, BeO, and BaO. In some examples, the glass comprises 15-45 wt. %, or 20-45 wt. %, or 20-40 wt. %, or 25-40 wt. % MO, or any value or range disclosed therein. In some examples, the glass can comprise about 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 wt. % MO, or any value or range having endpoints disclosed herein.

Alkali oxides (Na₂O, K₂O, Li₂O, Rb₂O, or Cs₂O) serve as aids in achieving low melting temperature and low liquidus temperatures. Meanwhile, the addition of alkali oxides can improve bioactivity. In some examples, the glass can comprise a total of 0-30 wt. % Na₂O, K₂O, Li₂O, Rb₂O, and Cs₂O combined.

Additional components can be incorporated into the glass to provide additional benefits or may be incorporated as contaminants typically found in commercially-prepared glass. For example, additional components can be added as coloring or fining agents (e.g., to facilitate removal of gaseous inclusions from melted batch materials used to produce the glass) and/or for other purposes. In some examples, the glass may comprise one or more compounds useful as ultraviolet radiation absorbers. In some examples, the glass can comprise 3 wt. % or less ZnO, TiO₂, CeO, MnO, Nb₂O₅, MoO₃, Ta₂O₅, WO₃, SnO₂, Fe₂O₃, As₂O₃, Sb₂O₃, Cl, Br, or combinations thereof. In some examples, the glass can comprise from 0 to about 3 wt. %, 0 to about 2 wt. %, 0 to about 1 wt. %, 0 to 0.5 wt. %, 0 to 0.1 wt. %, 0 to 0.05 wt. %, or 0 to 0.01 wt. % ZnO, TiO₂, CeO, MnO, Nb₂O₅, MoO₃, Ta₂O₅, WO₃, SnO₂, Fe₂O₃, As₂O₃, Sb₂O₃, Cl, Br, or combinations thereof. The glasses, according to some examples, can also include various contaminants associated with batch materials and/or introduced into the glass by the melting, fining, and/or forming equipment used to produce the glass. For example, in some embodiments, the glass can comprise from 0 to about 3 wt. %, 0 to about 2 wt. %, 0 to about 1 wt. %, 0 to about 0.5 wt. %, 0 to about 0.1 wt. %, 0 to about 0.05 wt. %, or 0 to about 0.01 wt. % SnO₂ or Fe₂O₃, or combinations thereof.

### EXAMPLES

The embodiments described herein will be further clarified by the following examples.

Non-limiting examples of amounts of precursor oxides for forming the embodied glasses are listed in Table 1, along with the properties of the resulting glasses. Anneal points were measured using a beam bending viscometry (BBV) method.

TABLE 1

| | Comp. | Comp. | | | | | | | | | | | |
|---|---|---|---|---|---|---|---|---|---|---|---|---|---|
| Oxide (wt. %) | Ex. 1 | Ex. 2 | 1 | 2 | 3 | 4 | 5 | 6 | 7 | 8 | 9 | 10 | 11 |
| SiO₂ | 70.8 | 45 | 42.9 | 42.4 | 42.0 | 41.2 | 31.8 | 21.1 | 54.3 | 46.3 | 38.7 | 38.7 | 38.7 |
| Al₂O₃ | 0 | 0 | 0 | 0 | 0 | 0 | 0 | 0 | 0 | 0 | 2.5 | 0 | 0 |
| Na₂O | 24.3 | 24.5 | 0 | 0 | 0 | 0 | 0 | 0 | 0 | 0 | 0 | 0 | 0 |
| K₂O | 6 | 0 | 0 | 0 | 0 | 0 | 0 | 0 | 0 | 0 | 0 | 0 | 0 |
| MgO | 0 | 0 | 14.5 | 14.3 | 14.2 | 13.9 | 10.6 | 7.0 | 8.0 | 18.5 | 14.5 | 14.5 | 14.5 |
| CaO | 4.9 | 24.5 | 32.4 | 32.1 | 31.8 | 31.2 | 36.1 | 41.7 | 29.9 | 27.8 | 30.0 | 27.5 | 30.0 |
| SrO | 0 | 0 | 0 | 0 | 0 | 0 | 0 | 0 | 0 | 0 | 0 | 5.0 | 0 |
| ZnO | 0 | 0 | 0 | 0 | 0 | 0 | 0 | 0 | 0 | 0 | 0 | 0 | 2.5 |
| F⁻ | 0 | 0 | 0.8 | 0.8 | 0.8 | 0.8 | 1.4 | 2.2 | 0 | 0 | 0.8 | 0.8 | 0.8 |
| P₂O₅ | 8 | 6 | 9.5 | 9.4 | 9.3 | 9.1 | 16.2 | 24.2 | 5.9 | 5.6 | 9.5 | 9.5 | 9.5 |
| ZrO₂ | 0 | 0 | 0 | 1.0 | 2.0 | 3.8 | 3.8 | 3.8 | 2.0 | 1.9 | 4.0 | 4.0 | 4.0 |
| Anneal Pt (° C.) | 600 | 500 | 400 | 400 | 400 | 400 | 375 | 350 | 450 | 450 | 425 | 425 | 425 |

The bioactive glass compositions disclosed herein exhibit high chemical durability and excellent bioactivity and can be in any form that is useful for the medical and dental processes disclosed. The compositions can be in the form of, for example, particles, powder, microspheres, fibers, sheets, beads, scaffolds, woven fibers. The compositions of Table 1 may be melted at temperatures below 1300° C., or at temperatures below 1250° C., or at temperatures below 1200° C., thereby making it possible to melt in relatively small commercial glass tanks.

In some embodiments, the compositions of Table 1 demonstrate improved chemical stability over Comparative Example 1 (an alkali-containing bioactive glass) or Comparative Example 2 (45S5 glass).

FIG. 1 illustrates weight loss characterization of Examples 1-4 and Comparative Example 1 when immersed in artificial saliva at 37° C. for 7 days. Weight loss of glass in FIG. 1 was calculated by measuring the weight of a glass disc (12.7 mm in diameter×2 mm in thickness) before and after soaking in artificial saliva. From FIG. 1, Examples 1 and 2 fall within HGB 2 category, while Comparative Examples 1 and 2 fall within HGB 5+, based on ISO 719 testing in aqueous water. HGB stands for hydrolytic resistance of glass grains under a boiling water test. A smaller number HGB indicates a higher resistance (greater durability), according to ISO 719. This indicates a significant improvement in water durability for at least Examples 1 and 2. In other words, when tested in artificial saliva, the weight loss for Examples 1-4 is less than one twentieth of Comparative Example 1.

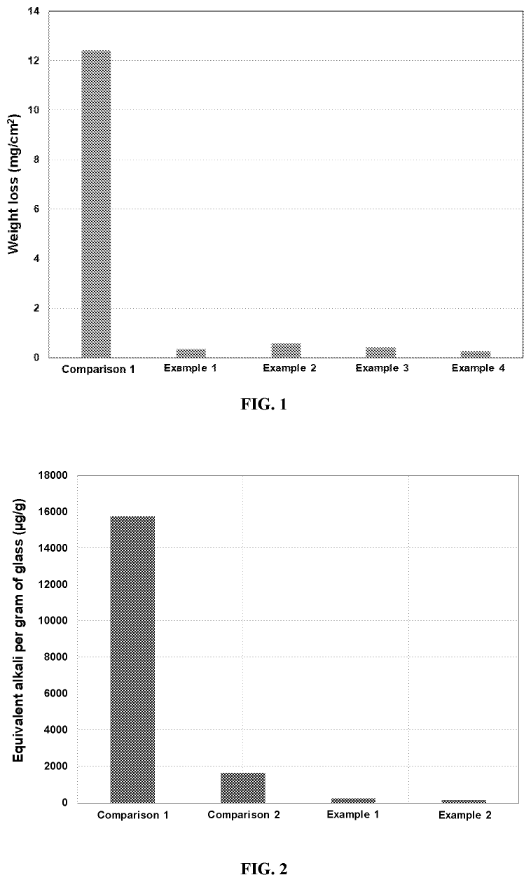

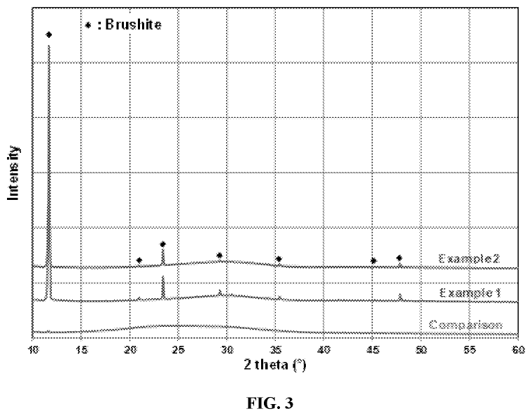

FIG. 2 illustrates equivalent alkali per gram of Examples 1 and 2 and Comparative Examples 1 and 2 when tested in water at 98° C. for 2 hrs according to ISO 719 standard procedure. In other words, equivalent alkali release in FIG. 2 was measured using a titration method of 50 mL of DI water containing glass grains for 2 hrs at 98° C., as specified by ISO 719. The solution is titrated with 0.01 M HCl using methyl red as an indicator and reported as g neutralized alkali per gram of grains, as described in ISO 719. A higher alkali release indicates a lower water durability of the glass composition. Thus, because the equivalent alkali release from Example 1 and Example 2 is about one tenth of that from Comparative Example 2 (45S5), Comparative Example 2 has a lower water durability than either Example 1 or Example 2. What the data in FIGS. 1 and 2 indicate is that glass compositions with higher durability ensures a longer shelf time when being used in an aqueous solution. With respect to Comparative Example 2, dental applications using this compositions are currently formulated with a non-aqueous solution. The current Examples of Table 1, which have improved water durability, allow flexibility in formulating with both aqueous and non-aqueous solutions, making them better candidates in dental or oral care or beauty product applications.

FIG. 3 illustrates powder x-ray diffraction (XRD) analysis on Examples 1 and 2 and Comparative Example 1 after soaking in potassium phosphate (KH₂PO₄) at 25° C. for 14 days. Both Examples 1 and 2 form brushite (CaHPO₄·2H₂O), a known bioactive ceramic, which suggests a higher crystallinity and better bioactivity than Comparative Example 1, within which very little amount of brushite is observed due to very low rates of formation. Because calcium is a key component in brushite, a higher CaO concentration favors faster brushite formation. Both Examples 1 and 2 have much higher concentrations of CaO than Comparative Example 1.

### Glass Bioactivity

Aspects are related to compositions or matrices containing embodied bioactive glass compositions and the methods of using the matrices to treat medical conditions. The matrices can be a toothpaste, mouthwash, rinse, spray, ointment, salve, cream, bandage, polymer film, oral formulation, pill, capsule, transdermal formulation, and the like. The bioactive glass compositions claimed can be physically or chemically attached to matrices or other matrix components, or simply mixed in. As noted above, the bioactive glass can be in any form that works in the application, including particles, beads, particulates, short fibers, long fibers, or woolen meshes. The methods of using the glass-containing matrices to treat a medical condition can be simply like the use of matrix as normally applied.

### Glass Making Processes

Glasses having the oxide contents listed in Table 1 can be made via traditional methods. For example, in some examples, the precursor glasses can be formed by thoroughly mixing the requisite batch materials (for example, using a turbular mixer) in order to secure a homogeneous melt, and subsequently placing into silica and/or platinum crucibles. The crucibles can be placed into a furnace and the glass batch melted and maintained at temperatures ranging from 1100° C. to 1400° C. for times ranging from about 6 hours to 24 hours. The melts can thereafter be poured into steel molds to yield glass slabs. Subsequently, those slabs can be transferred immediately to an annealer operating at about 400° C. to 700° C., where the glass is held at temperature for about 0.5 hour to 3 hours and subsequently cooled overnight. In another non-limiting example, precursor glasses are prepared by dry blending the appropriate oxides and mineral sources for a time sufficient to thoroughly mix the ingredients. The glasses are melted in platinum crucibles at temperatures ranging from about 1100° C. to 1400° C. and held at temperature for about 6 hours to 16 hours. The resulting glass melts are then poured onto a steel table to cool. The precursor glasses are then annealed at appropriate temperatures.

The embodied glass compositions can be ground into fine particles in the range of 1-10 microns (m) by air jet milling or short fibers. The particle size can be varied in the range of 1-100 m using attrition milling or ball milling of glass frits. Furthermore, these glasses can be processed into short fibers, beads, sheets or three-dimensional scaffolds using different methods. Short fibers are made by melt spinning or electric spinning; beads can be produced by flowing glass particles through a hot vertical furnace or a flame torch; sheets can be manufactured using thin rolling, float or fusion-draw processes; and scaffolds can be produced using rapid prototyping, polymer foam replication and particle sintering. Glasses of desired forms can be used to support cell growth, soft and hard tissue regeneration, stimulation of gene expression or angiogenesis.

Continuous fibers can be easily drawn from the claimed composition using processes known in the art. For example, fibers can be formed using a directly heated (electricity passing directly through) platinum bushing. Glass cullet is loaded into the bushing, heated up until the glass can melt. Temperatures are set to achieve a desired glass viscosity (usually <1000 poise) allowing a drip to form on the orifice in the bushing (Bushing size is selected to create a restriction that influences possible fiber diameter ranges). The drip is pulled by hand to begin forming a fiber. Once a fiber is established it is connected to a rotating pulling/collection drum to continue the pulling process at a consistent speed. Using the drum speed (or revolutions per minute RPM) and glass viscosity the fiber diameter can be manipulated—in general the faster the pull speed, the smaller the fiber diameter. Glass fibers with diameters in the range of 1-100 μm can be drawn continuously from a glass melt. Fibers can also be created using an updraw process. In this process, fibers are pulled from a glass melt surface sitting in a box furnace. By controlling the viscosity of the glass, a quartz rod is used to pull glass from the melt surface to form a fiber. The fiber can be continuously pulled upward to increase the fiber length. The velocity that the rod is pulled up determines the fiber thickness along with the viscosity of the glass.

Thus, as presented herein, biocompatible inorganic compositions for consumer and dental applications are described having a combination of improved bioactivity and chemical durability in aqueous environments.

As used herein, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination.

References herein to the positions of elements (e.g., “top,” “bottom,” “above,” “below,” “first,” “second,” etc.) are merely used to describe the orientation of various elements in the FIGURES. It should be noted that the orientation of various elements may differ according to other exemplary embodiments, and that such variations are intended to be encompassed by the present disclosure. Moreover, these relational terms are used solely to distinguish one entity or action from another entity or action, without necessarily requiring or implying any actual such relationship or order between such entities or actions.

Modifications of the disclosure will occur to those skilled in the art and to those who make or use the disclosure. Therefore, it is understood that the embodiments shown in the drawings and described above are merely for illustrative purposes and not intended to limit the scope ofthe disclosure, which is defined by the following claims, as interpreted according to the principles of patent law, including the doctrine of equivalents.

It will be understood by one having ordinary skill in the art that construction of the described disclosure, and other components, is not limited to any specific material. Other exemplary embodiments of the disclosure disclosed herein may be formed from a wide variety of materials, unless described otherwise herein.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

As utilized herein, “optional,” “optionally,” or the like are intended to mean that the subsequently described event or circumstance can or cannot occur, and that the description includes instances where the event or circumstance occurs and instances where it does not occur. As used herein, the indefinite articles “a,” “an,” and the corresponding definite article “the” mean “at least one” or “one or more,” unless otherwise specified. It also is understood that the various features disclosed in the specification and the drawings can be used in any and all combinations.

With respect to the use of substantially any plural and/or singular terms herein, those having skill in the art can translate from the plural to the singular and/or from the singular to the plural as is appropriate to the context and/or application. The various singular/plural permutations may be expressly set forth herein for the sake of clarity.

Unless otherwise specified, all compositions are expressed in terms of as-batched weight percent (wt. %). As will be understood by those having ordinary skill in the art, various melt constituents (e.g., silicon, alkali- or alkaline-based, boron, etc.) may be subject to different levels of volatilization (e.g., as a function of vapor pressure, melt time and/or melt temperature) during melting of the constituents. As such, the as-batched weight percent values used in relation to such constituents are intended to encompass values within +0.5 wt. % of these constituents in final, as-melted articles. With the forgoing in mind, substantial compositional equivalence between final articles and as-batched compositions is expected.

It will be apparent to those skilled in the art that various modifications and variations can be made without departing from the spirit or scope of the claimed subject matter. Accordingly, the claimed subject matter is not to be restricted except in light of the attached claims and their equivalents.

What is claimed is:

1. A silicate-based glass composition, comprising:
15-35 wt. % SiO₂;
9-25 wt. % MgO;
18-30 wt. % P₂O₅;
15-50 wt. % CaO;
less than 4 wt. % Al₂O₃;
3-10 wt. % ZnO; and
greater than 0 to 10 wt. % ZrO₂.

2. The silicate-based glass composition of claim 1, further comprising:
0-5 wt. % F⁻.

3. The silicate-based glass composition of claim 2, further comprising:
0-10 wt. % SrO.

4. The silicate-based glass composition of claim 1, wherein the glass comprises:
15-50 wt. % MO; and
0-30 wt. % R₂O,
wherein MO is the sum of MgO, CaO, SrO, BeO, and BaO, and
R₂O is the sum of Na₂O, K₂O, Li₂O, Rb₂O, and Cs₂O.

5. A silicate-based glass composition, comprising:
15-35 wt. % SiO₂;
2.5-25 wt. % MgO;
18-30 wt. % P₂O₅;
15-50 wt. % CaO;
0-5 wt. % F⁻;
less than 4 wt. % Al₂O₃;
0-10 wt. % ZnO; and
greater than 0 to 10 wt. % ZrO₂.

6. The silicate-based glass composition of claim 5, further comprising
0-10 wt. % SrO.

7. A silicate-based glass composition, comprising:
20-35 wt. % SiO₂;
9-20 wt. % MgO;
18-25 wt. % P₂O₅;
25-45 wt. % CaO;
less than 4 wt. % Al₂O₃;
0-10 wt. % ZnO; and
greater than 0 to 10 wt. % ZrO₂.

8. The silicate-based glass composition of claim 7, further comprising:
0-3 wt. % F⁻, and
1-6 wt. % ZrO₂.

9. The silicate-based glass composition of claim 8, further comprising 0-5 wt. % SrO.

10. The silicate-based glass composition of claim 1 configured to form a ceramic within fourteen days of immersion in a salt solution.

11. The silicate-based glass composition of claim 10, wherein the ceramic comprises brushite and the salt solution comprises potassium phosphate.

12. The silicate-based glass composition of claim 1, having a melting temperature of below 1300° C.

13. The silicate-based glass composition of claim 1, wherein a sum of P₂O₅ and CaO is from 25-65 wt. %.

14. The silicate-based glass composition of claim 1 configured to form an apatite when immersed in a simulated body fluid (SBF).

15. The silicate-based glass composition of claim 1, wherein the silicate-based glass composition is essentially free of Na₂O and K₂O.

16. The silicate-based glass composition of claim 1, comprising a particle, bead, particulate, short fiber, long fiber, woolen mesh, combination thereof.

17. The silicate-based glass composition of claim 16, having at least one size dimension in a range of 1-100 μm.

18. A matrix comprising the silicate-based glass composition of claim 1, wherein the matrix includes at least one of: a toothpaste, mouthwash, rinse, spray, ointment, salve, cream, bandage, polymer film, oral formulation, pill, capsule, or transdermal formulation.

19. The matrix of claim 18, wherein the silicate-based glass composition is attached to the matrix or mixed therein.

20. An aqueous environment comprising the silicate-based glass composition of claim 1.
